(19) United States
(12) Patent Application Publication
(10) Pub. No.: US 2006/0097477 A1
(43) Pub. Date: May 11, 2006

(54) Manual tilt/lift module

(75) Inventors: David Le, Fresno, CO (US); Rex W. Stevens, Longmont, CO (US); Darin J. Trippensee, Fresno, CO (US); Thomas Lockton, Clovis, CA (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG Inc.

(21) Appl. No.: 11/246,514

(22) Filed: Oct. 7, 2005

Related U.S. Application Data
(60) Provisional application No. 60/621,526, filed on Oct. 22, 2004.

(51) Int. Cl. A61G 5/10

(52) U.S. Cl. 280/304.1

(57) ABSTRACT

A module that is adapted to be situated between a base and a seat. The module has ends that are independently adjustable to selectively raise the seat, lower the seat, and tilt the seat. The module is particularly suitable for use with a wheelchair to selectively raise, lower, and tilt the wheelchair seat.

### CROSS REFERENCE TO RELATED APPLICATIONS

This application claims the benefit of U.S. Provisional Patent Application No. 60/621,526, filed on Oct. 22, 2004.

### BACKGROUND OF INVENTION

This invention relates in general to personal mobility vehicles and more particularly, to accessories for personal mobility vehicles. Most particularly, this invention relates to the seating aspect of wheelchairs and like vehicles.

It is known to provide a lifting device for adjusting the height of the seat of a wheelchair. Such a device enables a person seated in the seat to be raised or lowered. However, known lifting devices are of limited use in that the devices are usually permanently fixed to the wheelchair and may encumber the same.

To address the foregoing deficiencies, there has been provided a device, which serves as a height adjustable seat for a conventional wheelchair, and which is removable in nature. However, this device has a motor, which adversely affects the minimum height of the seat. Moreover, the motor requires power, and thus is not suitable for use with a manual wheelchair. Further, the device functions only to lift the wheelchair seat, not to tilt the wheelchair seat, as is often desired.

Thus, while a current device enables a disabled person to adjust the height of the wheelchair seat, there is no simple way to change a conventional manual wheelchair to permit its seat to be tilted or lifted without adversely affecting the minimum height of the wheelchair. What is need is a lifting device for adjusting the tilt angle or height of the seat of a manual wheelchair without adversely affecting the minimum height of the seat.

The present invention is directed towards a lifting device that meets the foregoing needs. The device comprises a module that is adapted to be situated between a base and a seat. The module has ends that are independently adjustable to selectively raise, lower, and tilt the seat.

The present invention is also directed towards a wheelchair comprising a base, a seat, and a module between the base and the seat. The module has ends that are independently adjustable to selectively raise the seat, lower the seat, and tilt the seat.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a side perspective view of a adjustable manual tilt/lift module of the present invention at its maximum height.

FIG. 2 is a side elevational view of the module shown in FIG. 1.

FIG. 3 is a side elevational view of the module at its intial or minimum height.

FIG. 4 is a bottom plan view of the module shown in FIG. 3 with a bottom plate removed to shown threaded engagement of adjustment shafts.

FIG. 5 is a side elevational view of the module at its maximum negative angle.

FIG. 6 is a side elevational view of the module lowered and at a negative angle.

FIG. 7 is a side elevational view of the module at its maximum positive angle.

### DETAILED DESCRIPTION

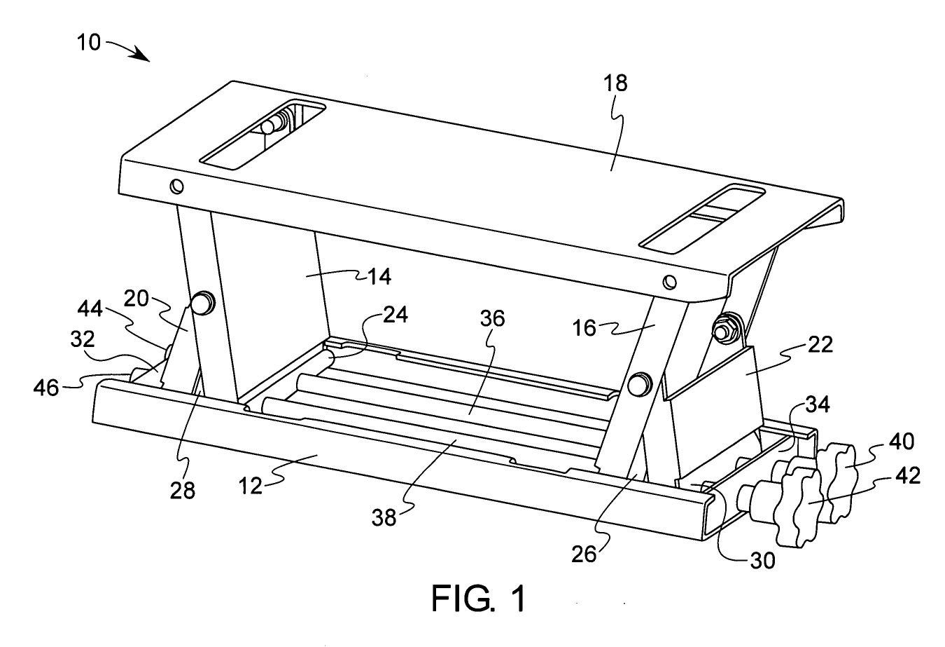

Referring now to the drawings, there is illustrated in FIG. 1 an adjustable manual tilt/lift module 10, which is adapted to support a wheelchair seat (not shown) relative to a wheelchair base (also not shown).

As seen in FIGS. 1-4, the module 10 includes a bottom support member, such as the bottom plate 12 shown, intermediate support members, such as the primary links 14, 16 shown, and a top support member, such as the top plate 18 shown. Top ends of the primary links 14, 16 are pivotally connected to opposing ends of the top plate 18. Bottom ends of the primary links 14, 16 are slidably and pivotally connected to the bottom plate 12. Interconnecting members, such as the secondary links 20, 22 shown, interconnect ends of the bottom plate 12 to the intermediate portions of the primary links 14, 16. At the bottom ends of the primary links 14, 16 are adjustable drive or nut bars 24, 26, which are provided with threaded openings. At the bottom ends of the secondary links 20, 22 are slide bars 28, 30, which are provided with non-threaded openings. At opposing ends of the bottom plate 12 are end bars 32, 34, which are fixed relative to the bottom plate 12, and which are provided with non-threaded openings. Adjustment shafts, such as the threaded bars 36, 38 shown, pass through the non-threaded openings in the end bars 32, 34, the non-threaded openings in the slide bars 28, 30, and thread to threaded openings in corresponding nut bars 24, 26. It should be appreciate that one of the threaded bars 36 passes through a non-threaded opening in one of the nut bars 26 and threads into the threaded opening in the other nut bar 24. Similarly, the other threaded bar 38 passes through a non-threaded opening in one of the nut bars 24 and threads into the threaded opening in the other nut bar 26.

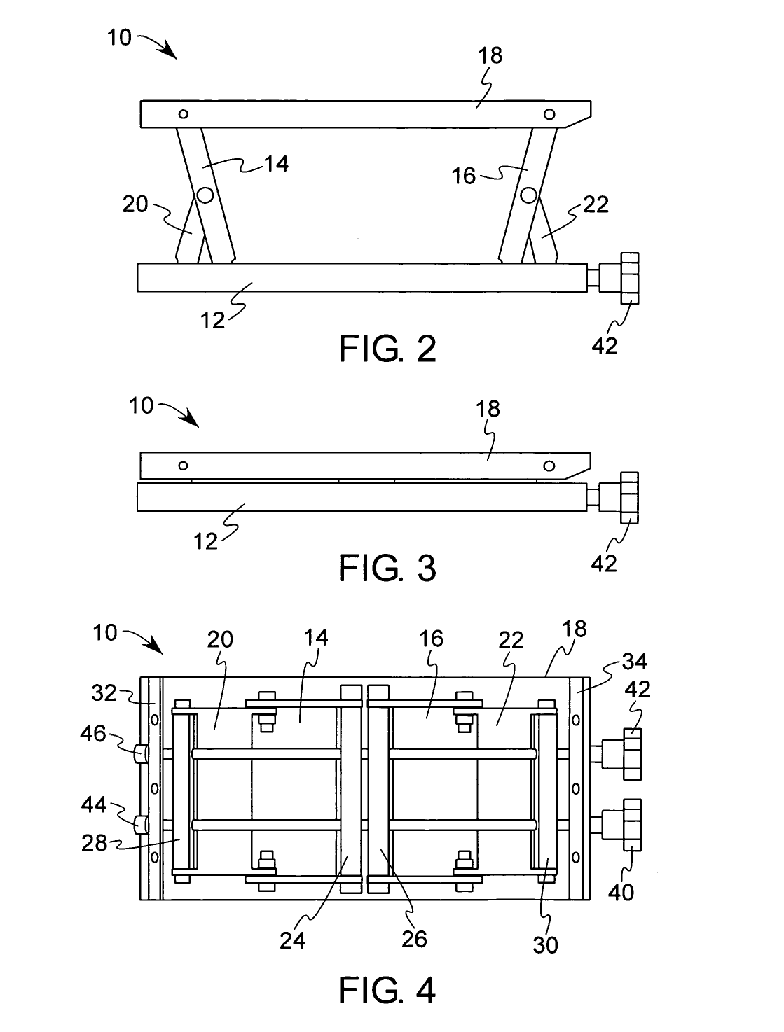

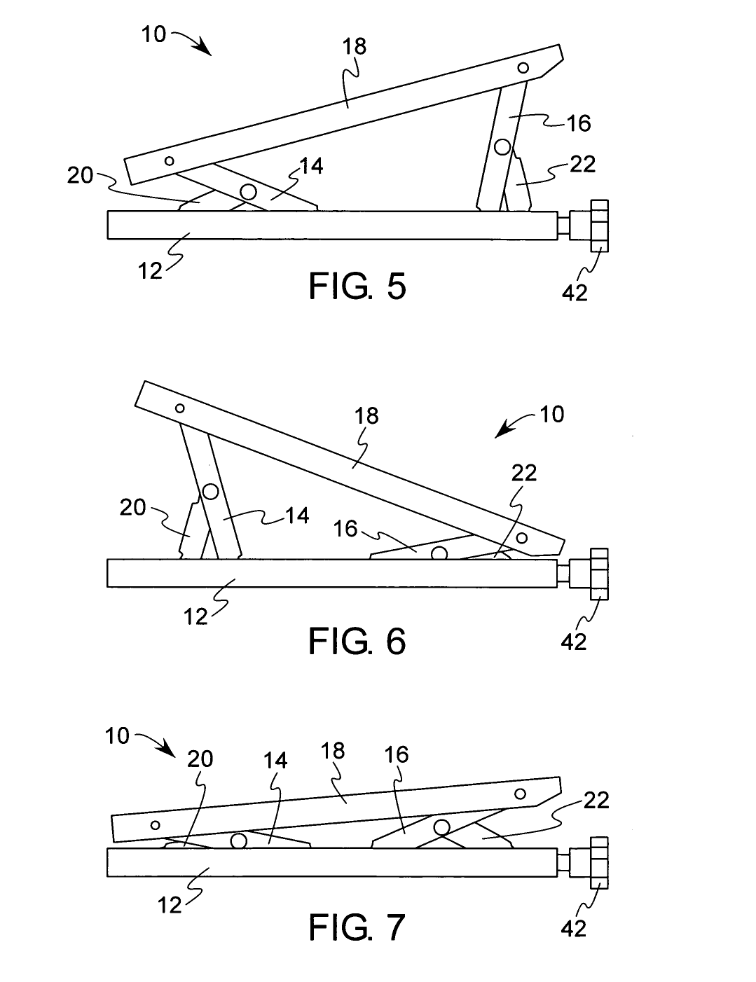

A knob 40, 42 is associated with an end of each threaded bar 36, 38 and a collar 44, 46 is associated with an opposing end of each threaded bar 36, 38. The knobs 40, 42 and collars 44, 46 hold the threaded bars 36, 38 in a substantially fixed axial position with respect to the end bars 32, 34 and the bottom plate 12. The knobs 40, 42 can be independently hand operated to independently turn the threaded bars 36, 38. Turning each knob 40, 42 in one direction raises a corresponding end of the top plate 18, as shown in FIGS. 1 and 2, and turning each knob 40, 42 in a opposite direction lowers a corresponding end of the top plate 18, as shown in FIG. 3. From an initial position shown in FIG. 3, turning one knob 42 raises one end of the top plate 18 to produce a negative tilt angle, as shown in FIG. 7, and turning the other knobs 40 raises one end of the top plate 18 to produce a positive tilt angle, as shown in FIG. 6. It should be appreciated that the knobs 40, 42 can be turned as desired to produce a combination of a desired tilt and lift, as shown in FIG. 5.

A seat (not shown) is adapted to be supported by the top plate 18. The seat preferably includes a bottom made of rigid material to support a person when seated thereon as well as a soft cushion disposed on top of the bottom. The seat may be formed in any variety of configurations. For example, the seat may be formed with a central raised edge portion, the purpose of which is to aid in leg comfort and support to the user. By raising and lowering the top plate 18, the seat is lifted or tilted accordingly.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair comprising:
a base;
a seat; and
a module between the base and the seat, the module having ends that are independently adjustable to selectively raise, lower, and tilt the seat.

2. The wheelchair according to claim 1, further including a control knob operatively connected to said module for controlling operation of said module.

3. The wheelchair according to claim 1, wherein said module includes movably interconnected members, wherein at least one of said members has a threaded open surface, and a threaded bar threadably connected to said threaded open surface, wherein turning of said threaded bar causes movement of said members in a manner to raise and lower said seat.

4. An adjustable manual tilt/lift module, which is adapted to support a wheelchair seat relative to a wheelchair base, the module comprising:
a first support member;
a second support member;
a first intermediate support member having a first end pivotally connected relative to a first end of the first support member and a second end slidably and pivotally connected relative to a first end of the second support member, the second end of the first intermediate support member being provided with a first nut bar, which is provided with a threaded opening, the second support member being provided with a first end bar, which is fixed relative to the second support member, and which is provided with a non-threaded opening; and
a first threaded bar passing through the non-threaded opening in the first end bar and threaded through the threaded opening in the first nut bar, whereby turning the first threaded bar in a first direction raises the first end of the first support member and turning the first threaded bar in a second direction, opposite the first direction, lowers the first end of the first support member.

5. The module of claim 4 wherein the first support member is a top support plate and second support member is a bottom support plate.

6. The module of claim 4 further comprising:
a second intermediate support member having a first end pivotally connected relative to a second end of the first support member and a second end slidably and pivotally connected relative to a second end of the second support member, the second end of the second intermediate support member being provided with a second nut bar, which is provided with a threaded opening, the second support member being provided with a second end bar, which is fixed relative to the second support member, and which is provided with a non-threaded opening; and
a second threaded bar passing through the non-threaded opening in the second end bar and threaded through the threaded opening in the second nut bar, whereby turning the second threaded bar in a first direction raises the second end of the first support member and turning the second threaded bar in a second direction, opposite the first direction, lowers the second end of the first support member.

7. The module of claim 6 further comprising a first interconnecting member interconnecting the second support member relative to the first intermediate support members and a second interconnecting member interconnecting the second support member relative to the second intermediate support members.

8. The module of claim 6 further comprising a knob associated with an end of each threaded bar, the knobs being independently hand operable to independently turn the threaded bars, whereby turning each knob in one direction raises a corresponding end of the top support plate and turning each knob in a opposite direction lowers a corresponding end of the top support plate, and whereby from an initial position, turning one knob raises one end of the top support plate to produce a negative tilt angle and turning the other knobs raises one end of the top support plate to produce a positive tilt angle.

9. The module of claim 8 further comprising a collar associated with an opposing end of each threaded bar, the knobs and collars holding the threaded bars in a substantially fixed axial position with respect to the end bars and the bottom support plate.

10. An adjustable manual tilt/lift module, which is adapted to support a wheelchair seat relative to a wheelchair base, the module comprising:
a top support plate;
a bottom support plate, primary links having top ends that are pivotally connected relative to opposing ends of the top support plate and bottom ends that are slidably and pivotally connected relative to opposing ends of the bottom support plate;
secondary links interconnecting ends of the bottom support plate relative to intermediate portions of the primary links, the bottom ends of the primary links being provided with first and second adjustable nut bars, which are provided with threaded openings, the secondary links having bottom ends with slide bars, which are provided with non-threaded openings, the bottom support plate being provided with end bars, which are fixed relative to the bottom support plate, and which are provided with non-threaded openings; and
first and second threaded bars passing through the non-threaded openings in the end bars, the non-threaded openings in the slide bars, and thread to threaded openings in corresponding nut bars, whereby the first threaded bar passes through a non-threaded opening in the first nut bar and threads into the threaded opening in the second nut bar and the second threaded bar passes through a non-threaded opening in the second drive nut bar and threads into the threaded opening in the first nut bar.

11. The module of claim 10 further comprising a knob associated with an end of each threaded bar.

12. The module of claim 11 further comprising a collar associated with an opposing end of each threaded bar, the knobs and collars holding the threaded bars in a substantially fixed axial position with respect to the end bars and the bottom support plate, the knobs being independently hand operable to independently turn the threaded bars, whereby turning each knob in one direction raises a corresponding end of the top support plate and turning each knob in a opposite direction lowers a corresponding end of the top support plate, and whereby from an initial position, turning one knob raises one end of the top support plate to produce a negative tilt angle and turning the other knobs raises one end of the top support plate to produce a positive tilt angle.

13. The module of claim 11 further comprising a seat supported by the top support plate.
